(19) United States
(12) Patent Application Publication
(10) Pub. No.: US 2002/0015809 A1
(43) Pub. Date: Feb. 7, 2002

(54) Printing method

(76) Inventors: Helena Rantala, Lahti (FI); Minna Oksanen, Tupos (FI)

Correspondence Address: Charles R. Hoffmann, Esq., HOFFMANN & BARON, LLP, 6900 Jericho Turnpike, Syosset, NY, 11791, US

(21) Appl. No.: 09/876,826

(22) Filed: Jun. 7, 2001

(30) Foreign Application Priority Data
Jun. 15, 2000 (FI) 20001430

(51) Int. Cl. B44F 1/10; B29C 45/16

(52) U.S. Cl. 428/29; 264/1.34; 264/21; 264/132; 264/255

(57) ABSTRACT

A plastic structure (208) manufactured by injection molding, comprising a surface (208A) and a decorative print (202 to 204) at least partly covering the surface (208A). The decorative print (202 to 204) comprises, starting from the surface of the plastic structure (208), the following layers: a base color (204) and a texture (202) made of a functional colorant, whereby a critical angle exists, and at viewing angles larger than the critical angle with respect to the decorative print (200 to 204), the texture is transparent such that the base color (204) is visible.

### FIELD OF THE INVENTION

The invention can be applied to plastic structures manufactured by injection molding, which are used e.g. in portable devices and devices worn on the wrist, such as watches, wrist computers or the like. The invention relates particularly to the surface decoration of such plastic structures.

### BACKGROUND OF THE INVENTION

A technology called injection molding is a method for manufacturing plastic structures, such as covers of e.g. watches and heart rate monitors. In order to produce a product by injection molding, melted plastic is injected into a mold shaped according to the product to be manufactured.

While being manufactured, injection-molded products are often provided with a decorative print, such as textual graphics comprising text, symbols and characters and possible coloring, which at least partly covers the surface of a product. At its simplest, textual graphics are engraved on a product afterwards or they are provided in the mold as pre-imprinted recesses to be formed onto the product during injection molding. A part can be provided with a decorative print also afterwards, after being manufactured by injection molding, during post-mold decoration PMD. A plastic structure may also be decorated during casting, according to a technology called in-mold decoration IMD, which is described e.g. in publication EP 0953422A2. In the solution described in the publication, a decoration sheet comprising a decorative print is inserted into a mold, the mold is closed and the decoration sheet in the mold is covered with melted plastic. Depending on the IMD technology, the print is attached to the plastic structure either with or without the decoration sheet. Advantages of the IMD technology over other printing methods include e.g. that the method allows printing on three-dimensional surfaces and more than one color to be used.

In the prior art solutions used in the IMD technology, a decorative print is formed on the decoration sheet e.g. as one to ten layers of color. The colors used are generally colorants with good opacity, i.e. lack of transparency. In the known solutions, a decorative print actually consists of two layers: textual graphics and base color formed in the background of the textual graphics.

The prior art solution for producing decorative prints in connection with the IMD technology does, however, present some drawbacks. The known printing methods have not completely utilized the potential provided by the colors and plurality of printing color layers, and only few special effects in the visual appearance of a decorative print provided by different viewing angles have been presented.

### BRIEF DESCRIPTION OF THE INVENTION

An object of the invention is to provide an improved method and an apparatus implementing the method for producing a decorative print for plastic parts manufactured by injection molding.

The invention relates to a method for producing a decorative print onto a decoration sheet to be used in connection with injection molding when decorating a structure. The method comprises providing the decoration sheet with a decorative print comprising a texture using a functional colorant and a base color at least partly on top of the texture, whereby a critical angle exists for viewing the decorative print, and at viewing angles larger than the critical angle the texture is transparent such that the base color to be provided against the structure is visible, and an angle area exists comprising viewing angles smaller than the critical angle, from which angles the texture can be seen.

The invention also relates to a method for producing a surface decoration for a structure in connection with injection molding, the method comprising inserting a decoration sheet comprising a decorative print into a mold defining the shape of the structure and injecting melted structural material into the mold in order to produce the structure and decorate the structure with the decorative print in the decoration sheet. The decorative print of the decoration sheet comprises a base color to be provided against the plastic structure and a texture produced using a functional colorant, the texture being transparent when viewed from viewing angles larger than a critical angle with respect to the surface of the decorative print such that the base color is visible, the texture being visible at viewing angles smaller than the critical angle.

The invention also relates to a plastic structure manufactured by injection molding, comprising a surface and a decorative print at least partly covering the surface. Starting from the surface of the plastic structure, the decorative print comprises the following layers: a base color and a texture made of a functional color, whereby a critical angle exists, and at viewing angles larger than the critical angle with respect to the decorative print, the texture is transparent such that the base color is visible.

Preferred embodiments of the invention are disclosed in the dependent claims.

The invention thus relates to a method and an apparatus implementing the method for producing a print in connection with injection molding. The solution of the invention relates to prints produced using the known IMD technology wherein a decoration sheet comprising a decorative print is inserted into a mold. When melted plastic is injected into the mold, either the sheet and the decorations therein become attached to a plastic structure or the decorative material becomes detached from the decoration sheet. In the solution of the invention, the decorative print to be produced onto the plastic structure comprises a texture and a base color. A texture refers to patterning formed by shaping symmetric and/or asymmetric patterns. A base color refers to a layer of background color of a decorative print closest to a plastic structure. In the invention, the texture is produced using a functional colorant, such as a pearlescent color or an interference color. In connection with the description of the invention, a functional colorant thus refers to a colorant which comprises optic lamellas, discs, strips or other such elements affecting the way in which light is reflected or deflected. When viewing a functional colorant layer, a critical angle exists, and at viewing angles smaller than the critical angle, a phenomenon similar to optical total reflection occurs, which brings the texture formed using a functional colorant into view. When viewed from viewing angles larger than the critical angle, e.g. from a viewing angle substantially perpendicular with respect to the surface of the plastic structure, the colorant layer is transparent, i.e. in the solution of the invention, the base color is visible. When viewed from different angles, light is thus reflected to a viewer's eyes from different layers, e.g. when viewed from an angle smaller than the critical angle, light is reflected from the functional colorant layer, whereas when viewed from angles larger than the critical angle, light is reflected from the base color layer. The magnitude of the critical angle depends on the optical elements used in the functional colorant. A varnish contained in the functional colorant is transparent, which makes the colorant transparent when viewed from angles larger than the critical angle. In a preferred embodiment of the invention, the base color is light, enabling the special effect of the invention to be achieved optimally. Preferably, a solid color is used as the base color. It is obvious that color layers, such as textual graphics, can also be formed on top of the functional colorant layer; this, however, is not crucial to the invention.

It is obvious that the printing layers, textual graphics, texture and base color mentioned above can be printed or painted onto the decoration sheet as multiple layers without by any means restricting the invention to the number of printings. Preferably, the printing material is produced onto the decoration sheet using a technology called screen printing, wherein color is transferred to the material to be printed through a screen cloth. Screen printing is a known printing method, which enables patterns to be printed on many different materials, such as plastic, glass, wood or cloth.

According to the invention, a print is produced onto a decoration sheet to be placed against a plastic structure in the following order: a texture and a base color, which means that the texture is formed against the decoration sheet and the base color is arranged against the plastic structure during injection molding. Preferably, the decoration sheet comprising the decorative print is cut off in connection with injection molding to be attached to the plastic structure. In an embodiment, the decoration sheet is a double sheet, in which case the printing material is provided between two polymer sheets. The decoration sheet used is preferably made of polymer plastic, without, however, by any means restricting the invention to any specific polymer plastic.

An advantage of the invention is a special viewing effect wherein at certain viewing angles, the transparent texture produced using a functional colorant disappears such that the base color comes into view.

### BRIEF DESCRIPTION OF THE DRAWINGS

In the following, the invention will be described in closer detail with reference to the accompanying drawings, in which

FIG. 1 shows an apparatus used in injection molding,

FIG. 2A shows a structure of a decoration sheet according to an embodiment of the invention,

FIG. 2B shows texture patterns according to an embodiment of the invention,

FIG. 2C shows a viewing effect achieved by a solution of an embodiment of the invention.

FIG. 3 shows a preferred embodiment of a method of the invention.

### DETAILED DESCRIPTION OF THE INVENTION

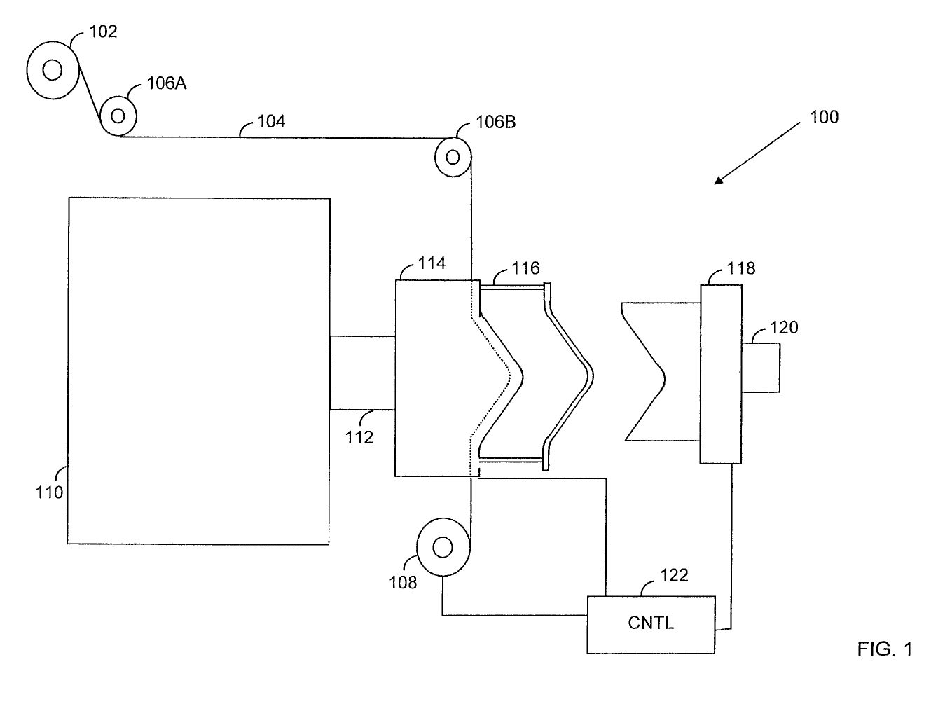

In the following, the invention will be described by means of preferred embodiments and with reference to the accompanying drawings 1 to 2C. FIG. 1 shows an arrangement 100 for manufacturing and coating plastic structures to be manufactured by injection molding using a technology called IMD. In the following, the arrangement will be described only for parts relevant to the invention, and it is obvious that the arrangement also comprises other parts than those shown in FIG. 1, the operation of those parts being, however, obvious to one skilled in the art.

The arrangement 100 comprises a reel-like pay-off coil 102 to feed a decoration sheet 104 comprising a decorative print to be used for decorating a plastic structure. In the present connection, decorating refers to decorative coloring, such as textual graphics, texture and base color, to be provided onto a plastic structure to be produced. According to the prior art, the sheet to be used can be a double sheet wherein colors are provided between two polymer sheets. The colors are then better protected from the effect of a pressure wave caused by injecting a melted plastic mass. The sheet may also be a decoration sheet comprising a single layer. The decoration sheet 104 being fed is controlled and held tight by means of control wheels 106A and 106B. The decoration sheet 104 passed through the arrangement 100 is collected on a reel-like take-up coil 108. The decoration sheet 104 can actually be transferred from the pay-off coil 102 to the take-up coil 108 in many ways, such as by means of several control wheels, rolling the take-up coil 108 or in another similar manner. The feeding rate and volume of the decoration sheet 104 can be controlled e.g. using control equipment 122 implemented e.g. by software. In a preferred embodiment of the invention, the sheet 104 and the printing material therein remain in the mold, in which case the arrangement 100 comprises a cutting edge for cutting the decoration sheet; no take-up coil 108 is then necessarily required.

A mold part comprises a first mold 114 and a second mold 118, which can be located in an open space or in a confined place with respect to each other. FIG. 1 shows an open space, in which case the first and the second molds exist separately from each other. Preferably, the first mold 114 comprises a cavity for melted plastic when the molds are located in a confined space with respect to each other. The first mold 114 can be moved by means of a transfer device 112 with respect to a supporting structure 110 of the arrangement. Although not shown in the figure, it is obvious that the arrangement 100 also comprises means for moving the second mold 118 towards and away from the first mold 114. Preferably, the movement of the molds with respect to each other is controlled by the control equipment 122. To the second mold 118, injection means 120 are connected for injecting melted plastic between the molds 114, 118 when the molds are located in a confined space with respect to each other. The molds used are manufactured e.g. of metal or a ceramic material.

The decoration sheet 104 is brought to the first mold 114 and tightened onto the mold by a press 116. The first mold 114 may comprise suction holes to suck the decoration sheet 104 tightly against the first mold 114. As is well known, the decoration sheet 104 may be preheated by a preheater, which makes the decoration sheet 104 easier to shape onto the first mold 114. Hot, high pressure oil can also be used to give the decoration sheet a three-dimensional shape. In an embodiment, the arrangement 100 also comprises a heater for detaching the material on the decoration sheet 104 from the decoration sheet 104 into the plastic structure. The preheater and heater can be implemented e.g. as a ceramic heater or a panel heater. The decoration sheet 104 is heated before the molds are placed in a confined space and before melted plastic is injected into the cavity.

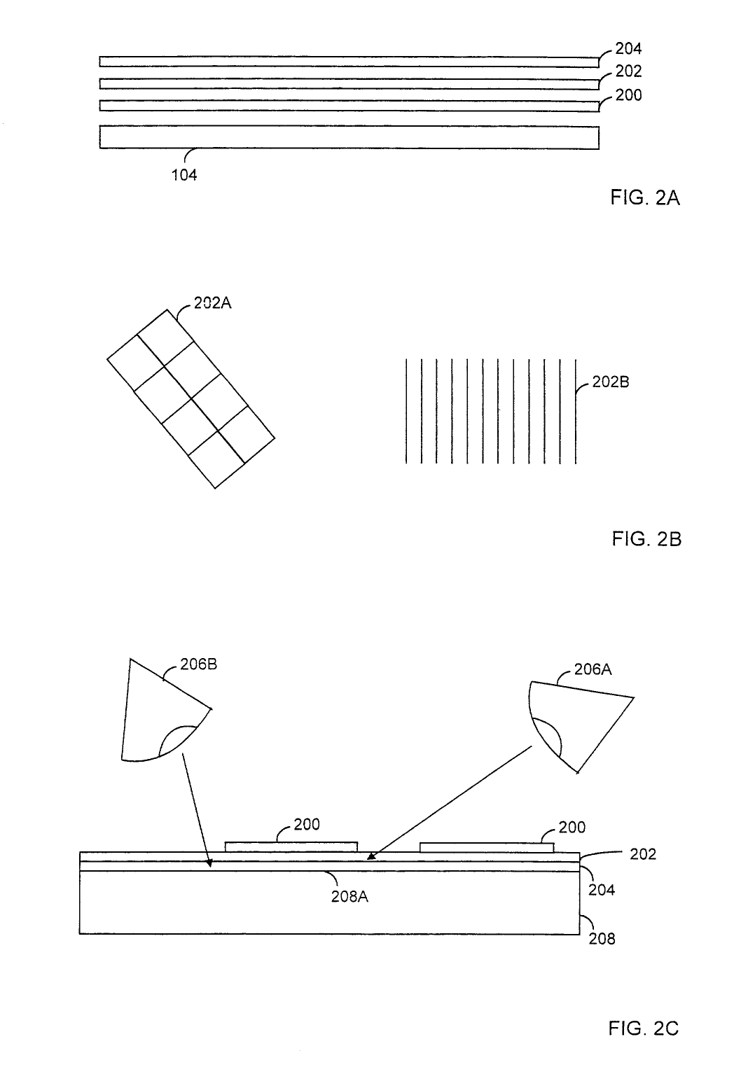

FIG. 2A shows the structure of a decoration sheet according to a preferred embodiment of the invention. The decoration sheet structure used as an example in FIG. 2A is a structure comprising one sheet, as distinct from a double sheet structure, without, however, restricting the invention to either sheet structure. The decoration sheet used in connection with the invention may be any known decoration sheet structure, such as a polymer sheet. First, the decoration sheet 104 is provided with textual graphics 200, such as symbols and text. The textual graphics 200 is printed or painted onto the sheet 104 using prior art technologies, such as screen printing. The textual graphics 200 is preferably printed using a solid color in 1 to 4 layers. A surface pattern 202, i.e. a texture, comprising symmetric and/or asymmetric figures, is provided on top of the textual graphics 200. According to the invention, the texture 202 is formed using a functional colorant, such as a pearlescent color or an interference color. A characteristic feature of the texture 202 formed using a functional colorant is that at certain angles of incidence of light, the texture 202 is transparent, or at least translucent, which means that the color material under the texture is visible. Herein, translucency refers to partial transparency caused by a transparent and colorless varnish contained in the functional colorant and the characteristic features of the optical elements. Preferably, the functional colorant is colorless, a possible coloring being produced by mixing a desired color pigment with the colorant. If, for example, the functional colorant is to be blue, a blue color pigment would be mixed with the colorless base color as a colorant or color powder.

On top of the texture 202, a base color 204 is provided onto the decoration sheet 104 e.g. by a common solid color. Preferably, the base color 204 is light and e.g. lighter than the base color used in the textual graphics. The base color 204 is preferably painted about 1 to 4 times, without restricting the invention thereto. In order to optimize the resolution power, i.e. contrast, between the base color and the texture, the shades of color to be used have to be selected discriminatively. If the base color used is very light, the texture can be printed using a darker colorant than in the case of a darker base color. The base color used in the invention is preferably a shade of gray on a CMYK (Cyan Magenta Yellow Black) scale. The scale is used for defining a shade of gray on a scale ranging from 0% to 100%, wherein 0% refers to lightest light and 100% refers to darkest dark. In the invention, the shade of gray of the base color is less than 50%, being 20% or 35% in some preferred embodiments of the invention. Preferably, heat- and UV-light-resistant solid colors are used in the textual graphics and as the base colors. Herein, a solid color refers to a basic color listed and encoded in common color charts, comprising no additives to change the characteristic features of the color.

By way of example, FIG. 2B shows two simple textures 202A and 202B comprising symmetric elements. Of course, textures may also be asymmetric, such as designs given cloud- or wave-patterned shapes. Furthermore, it is obvious that the texture may comprise both symmetric elements and asymmetric elements. FIG. 2C, in turn, shows a special effect in a final plastic structure 208 manufactured by injection molding to be achieved by a solution of the invention. The plastic structure 208 comprises a surface 208A at least partly covered by a decorative print. Although the surface 208A is shown in the figure as an even plane surface, it is obvious that the solution of the invention is also suitable for decorating a surface comprising roughnesses and three-dimensional surface profiles to the extent to which injection molding allows. The solution of the invention enables a scintillating decorative print highly resistant to wear and tear to be produced onto the plastic structure. Starting from the surface 208A of the plastic surface 208, the decorative print comprises the following layers: a base color 204, a texture 202 and textual graphics 200. The above-mentioned layers 200 to 204 at least partly overlap with each other such that the base color 204 and the texture 202 at least partly overlap. The textual graphics 200 according to an embodiment of the invention, in turn, at least partly overlap with the texture 202. At a certain viewing angle smaller than a critical angle and low with respect to the plastic structure 208, the viewing angle being designated by an eye 206A, the texture 202 formed using a functional colorant is visible to a viewer. At a viewing angle larger than the critical angle, the viewing angle being designated by an eye 206B, the viewer, through the transparent texture 202, can see the light base color 204 provided against the surface 208A of the plastic structure 208. The critical angle mentioned above is e.g. 45 degrees, which means that a phenomenon similar to optical total reflection occurs at angles smaller than 45 degrees with respect to the surface 208A of the plastic structure 208, whereas the transparency effect occurs at angles larger than the mentioned critical angle with respect to the surface 208A. The texture 202 according to an embodiment formed using a functional colorant provides a second critical angle, which is smaller than the critical angle mentioned. When viewed from viewing angles smaller than the second critical angle, the texture 202 disappears again and the base color 204 is reflected to the viewer. If a potential viewing angle area refers to an angle area from 0 to 90 degrees with respect to the surface, a viewing angle of 0 degrees refers to a viewing angle parallel with the surface plane and a maximum viewing angle of 90 degrees refers to a viewing angle parallel with the perpendicular of the surface. In the viewing angle area, then, a first angle area (e.g. 0 to 20 degrees) and a third angle area (45 to 90 degrees) exist from which the texture 202 is invisible, whereas in a second angle area (20 to 45 degrees) between the aforementioned angle areas the texture 202 is visible. The aforementioned viewing angle refers to an angle with respect to the surface, so it is obvious that the special effect according to the invention is achieved from the entire angular sector comprising all directions around the structure. The special effect according to the invention is thus not dependent on the direction from which the structure is being viewed, only on the angle between the viewer and the surface.

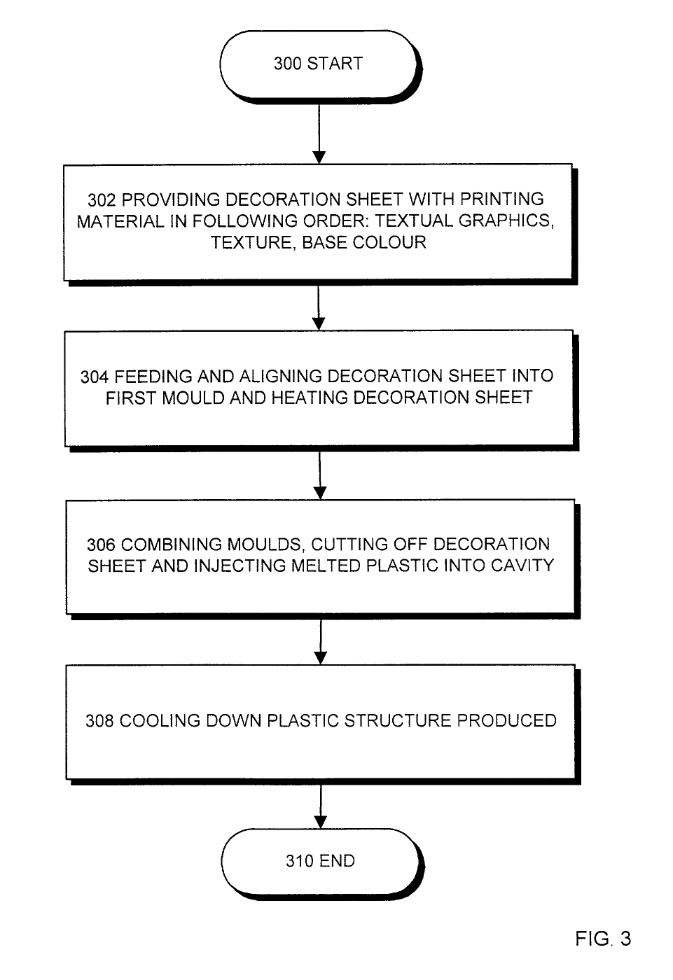

FIG. 3 shows a preferred embodiment of the method of the invention. In method step 302, a printing material is produced onto a single polymer sheet in the following order: a texture and a base color. The texture is thus printed onto a decoration sheet and the base color is provided outermost as seen from the decoration sheet. In method step 304, the decoration sheet is fed into a first mold and aligned therein, and the decoration sheet is heated in order to make the printing material easier to detach from the decoration sheet. In step 306, a second mold is brought into connection with the first mold, and the molds are combined in order to produce a confined space. Melted plastic is injected into a cavity formed in the space defined by the molds, the printing material located on the decoration sheet thus being attached to the plastic structure being produced. In step 308, the plastic structure is cooled down and the decoration sheet is removed from the production equipment.

Although the invention has been described above with reference to the examples in accordance with the accompanying drawings, it is obvious that the invention is not restricted thereto but can be modified in many ways within the scope of the inventive idea disclosed in the attached claims.

1. A method for producing a decorative print onto a decoration sheet to be used in connection with injection molding when decorating a structure, the method comprising providing the decoration sheet with a decorative print comprising a texture using a functional colorant and a base color at least partly on top of the texture, whereby a critical angle exists for viewing the decorative print, and at viewing angles larger than the critical angle the texture is transparent such that the base color to be provided against the structure is visible, and an angle area exists comprising viewing angles smaller than the critical angle, from which angles the texture can be seen.

2. A method as claimed in claim 1, wherein at viewing angles smaller than the viewing angles within said angle area, the texture is invisible.

3. A method as claimed in claim 1, wherein the functional colorant comprises optical lamellas, strips, discs or other such elements affecting the way in which light is reflected or deflected.

4. A method as claimed in claim 1, wherein the functional colorant is a pearlescent color or an interference color.

5. A method as claimed in claim 1, wherein the texture to be formed using a functional colorant comprises one or more of the following: one or more symmetrical patterns, one or more asymmetrical patterns, one or more design patterns.

6. A method as claimed in claim 1, wherein the base color used is a light color.

7. A method as claimed in claim 6, wherein the light color is a shade of gray on a CMYK scale, the degree of grayness of the shade of gray being less than 50%.

8. A method as claimed in claim 1, wherein the base color used is a solid color.

9. A method as claimed in claim 1, wherein the method for decorating an injection-molding structure used in the method is IMD and polymer plastic suitable for the IMD method is used as the decoration sheet.

10. A method as claimed in claim 1, the method comprising cutting off the decoration sheet containing the decorative print in connection with injection molding to be attached, together with the decorative print, to the structure being decorated.

11. A method as claimed in claim 1, the method comprising producing textual graphics lowermost onto the decoration sheet, and texture at least partly on top of the textual graphics comprising at least one of the following: text symbol, character, pattern.

12. A method as claimed in claim 1, the method comprising using screen printing in the decorative printing of the decoration sheet.

13. A method as claimed in claim 1, wherein the structure being subjected to decorative printing is made of polymer plastic.

14. A method as claimed in claim 1, wherein the structure being subjected to decorative printing is a three-dimensional part.

15. A method as claimed in claim 1, wherein the structure being subjected to decorative printing is a watch-like structure, such as a watch, heart rate monitor or a wrist computer.

16. A method for producing a surface decoration of a structure in connection with injection molding, the method comprising inserting a decoration sheet comprising a decorative print into a mold defining the shape of the structure and injecting melted structural material into the mold in order to produce the structure and decorate the structure with the decorative print in the decoration sheet, the decorative print of the decoration sheet comprising a base color to be provided against the plastic structure and a texture formed using a functional colorant, the texture being transparent when viewed from viewing angles larger than a critical angle with respect to the surface of the decorative print such that the base color is visible, and the texture being visible at viewing angles smaller than the critical angle.

17. A method as claimed in claim 16, wherein an angle area is provided in viewing angles of the decorative print that are smaller than said critical angle, and at the viewing angles within the angle area the texture is visible but at angles smaller than the angles defining the angle area the texture becomes invisible.

18. A method as claimed in claim 16, wherein the functional colorant comprises optical lamellas, strips, discs or other such elements affecting the way in which light is reflected or deflected.

19. A method as claimed in claim 16, wherein the functional colorant comprises optical lamellas, strips, discs or other such parts changing the direction of light.

20. A method as claimed in claim 16, wherein the functional colorant is a pearlescent color or an interference color.

21. A method as claimed in claim 16, wherein the texture to be formed using a functional colorant comprises one or more of the following: one or more symmetrical patterns, one or more asymmetrical patterns, one or more design patterns.

22. A method as claimed in claim 16, wherein the functional colorant is a shade of gray on a CMYK scale, the degree of grayness of the shade of gray being less than 50%.

23. A method as claimed in claim 16, wherein the method for decorating an injection molding structure used in the method is IMD and polymer plastic suitable for the IMD method is used as the decoration sheet.

24. A method as claimed in claim 16, the method comprising using screen printing in the decorative printing of the decoration sheet.

25. A method as claimed in claim 16, wherein the structure being subjected to decorative printing is a three-dimensional part.

26. A method as claimed in claim 16, wherein the structure being subjected to decorative printing is a watch-like structure, such as a watch, heart rate monitor or a wrist computer or the like.

27. A plastic structure manufactured by injection molding, comprising a surface and a decorative print at least partly covering the surface, wherein starting from the surface of the plastic structure, the decorative print comprises the following layers: a base color and a texture made of a functional colorant, whereby a critical angle exists, and at viewing angles larger than the critical angle with respect to the decorative print, the texture is transparent such that the base color is visible.

28. A plastic structure as claimed in claim 27, wherein the surface subjected to decorative printing comprises surface profiles different from the surface plane.

29. A plastic structure as claimed in claim 27, wherein at viewing angles smaller than the critical angle, the texture is visible.

30. A plastic structure as claimed in claim 27, wherein a second critical angle of viewing the decorative print exists, and at viewing angles smaller than the second critical angle the texture is invisible.

31. A plastic structure as claimed in claim 27, wherein the functional colorant comprises optical parts, such as lamellas, strips, discs or other such parts, which change the direction of light.

32. A plastic structure as claimed in claim 27, wherein the functional colorant is a pearlescent color or an interference color.

33. A plastic structure as claimed in claim 27, wherein the texture comprises one or more of the following: one or more symmetrical patterns, one or more asymmetrical patterns, one or more design patterns.

34. A plastic structure as claimed in claim 27, wherein the base color is a shade of gray on a CMYK scale, the degree of grayness of the shade of gray being less than 50%.

35. A plastic structure as claimed in claim 27, wherein the base color is a solid color.

36. A plastic structure as claimed in claim 27, wherein the plastic structure is a plastic structure manufactured using an injection molding method, and the decorative print of the plastic structure is produced using an IMD method, and polymer plastic suitable for the IMD method is used as the decoration sheet.

37. A plastic structure as claimed in claim 27, wherein the structure subjected to decorative printing is made of polymer plastic.

38. A plastic structure as claimed in claim 27, wherein the structure being subjected to decorative printing is a three-dimensional part.

39. A plastic structure as claimed in claim 27, wherein the structure being subjected to decorative printing is a watch-like portable device, such as a watch, wrist computer or a heart rate monitor.
